(19) United States
(12) Patent Application Publication
(10) Pub. No.: US 2018/0369897 A1
(43) Pub. Date: Dec. 27, 2018

(54) REINFORCING STRUCTURAL COMPONENTS

(71) Applicant: AUTOTECH ENGINEERING A.I.E., Amorebieta-Etxano (ES)

(72) Inventors: Laura GALCERAN OMS, Canet De Mar (ES); Oscar PRADAS BERTOLIN, Abrera (ES)

(21) Appl. No.: 15/779,811

(22) PCT Filed: Dec. 16, 2016
(86) PCT No.: PCT/EP2016/081456

§ 371 Date: May 29, 2018

(30) Foreign Application Priority Data
Dec. 18, 2015 (EP) 15382643.3

(51) Int. Cl. B21D 53/88; C21D 9/00; B23K 26/354; B21D 22/02

(52) U.S. Cl. CPC B21D 53/88; C21D 9/0068; B23K 2103/05; B21D 22/022; B23K 26/354

(57) ABSTRACT

A method for manufacturing reinforced steel structural components is described. The method comprises providing a steel blank, selecting one or more reinforcement zones of the steel blank, locally depositing a material on the reinforcement zone to create a local reinforcement on a first side of the steel blank. Locally depositing a material on the reinforcement zone comprises supplying a reinforcement material to the selected reinforcement zone, and substantially simultaneously applying laser heating to melt the reinforcement material and a portion of the steel blank to mix the melted reinforcement material with the melted portion of the steel blank. The method further comprises forming the steel blank with the locally deposited material to shape the reinforced steel structural component. The disclosure further relates to reinforced components obtained using such methods and tools used in such methods.

This application claims the benefit of European Patent Application EP15382643.3 filed on Dec. 18, 2015.

The present disclosure relates to methods and tools for manufacturing reinforced structural components and to the structural components obtained through these methods.

### BACKGROUND

The demand for weight reduction in e.g. the automotive industry has led to the development and implementation of lightweight materials, manufacturing processes and tools. The growing concern for occupant safety also leads to the adoption of materials which improve the integrity of the vehicle during a crash while also improving the energy absorption. In that sense, vehicle parts made of high-strength and ultra-high-strength steel are often employed in order to satisfy criteria for lightweight construction.

Typical vehicle components that need to meet weight goals and safety requirements include structural and/or safety elements such as door beams, bumper beams, cross/side members, A/B pillar reinforcements, and waist rail reinforcements.

For example, a process known as Hot Forming Die Quenching (HFDQ) uses boron steel sheets to create stamped components with Ultra High Strength Steel (UHSS) properties, with tensile strengths of at least 1000 MPa, preferably approximately 1500 MPa or up to 2000 MPa or more. The increase in strength allows for a thinner gauge material to be used, which results in weight savings over conventionally cold stamped mild steel components.

Simulations performed during the design phase of a typical vehicle component can identify points or zones of the formed component that need reinforcement (because lighter and thinner metal sheets and blanks are used) in order to increase strength and/or stiffness. Alternatively a redesign may be done in order to steer deformations and obtain a desired deformation behaviour.

In that sense, there are several procedures with which some areas of a component can be reinforced in order to redistribute stress and save weight by reducing the thickness of the component. These known procedures for reinforcing a component are, for example, “patchworks” in which partial or complete overlapping of several blanks may be used, or blanks or plates of different thickness that may be welded “edge to edge”, i.e. Tailor welded blanks (TWB). Structural mechanical requirements can thus be achieved theoretically with a minimum of material and thickness, i.e. weight.

When ultra-high strength steels (e.g. Usibor® 1500P) are being used to form tailor welded blanks and these blanks are subsequently hot formed, some weldability problems may arise due to an aluminum-silicon (AlSi) coating usually used to protect from corrosion and oxidation damage. When welding blanks together to form a tailor welded blank, the aluminum is mixed in the weld zone and this leads to reduced mechanical properties. In order to overcome these problems it is known to remove a part of the coating in an area close to the welding gap by laser ablation. However, this represents yet an additional step in the manufacturing process of a vehicle component.

Furthermore, when welded reinforcements (patchworks) are added to a blank, partial or complete overlapping of blanks occur. These areas are potential corrosion starting points as overlapped regions remain underneath and do not receive e.g. a corrosion coating.

In addition, depending on the component being formed there may be regions in which it is not possible or it is at least cumbersome to use welded reinforcements e.g. corners or areas with elevation changes. Patchworks are normally welded using a spot welding which requires a minimum space to distribute the spots. Additionally, patchworks need a minimum size in order to be easily welded. This may involve an extra weight as the reinforcement needs to have a minimum size in order to be welded rather than having the right size (minimum) needed to reinforce the required area.

The aforementioned problems and/or challenges are not unique to the automotive industry or to the materials and processes used in that industry. Instead these challenges may be encountered in any industry wherein weight reduction is an objective. When weight reduction is an objective, the components become ever thinner which can thus lead to an increased need for reinforcements.

It is an object of the present disclosure to provide improved methods of manufacturing reinforced structural components, particularly reinforced structural components with enhanced microstructure.

### SUMMARY

In a first aspect, a method for manufacturing reinforced steel structural components is provided. The method comprises providing an ultra-high strength steel blank, selecting one or more reinforcement zones of the steel blank, and locally depositing a material on the reinforcement zone to create a local reinforcement on a first side of the steel blank. Locally depositing a material on the reinforcement zone comprises supplying a reinforcement material to the selected reinforcement zone, and applying laser heating to melt the reinforcement material and a portion of the steel blank to mix the melted reinforcement material with the melted portion of the steel blank. The method further comprises forming the steel blank with the locally deposited material to shape the reinforced steel structural component.

According to this aspect, a local reinforcement process is carried out in an ultra-high strength steel blank to create reinforcements (e.g. ribs) on the blank prior to forming. By applying a reinforcement material and applying laser heating, widely varying reinforcements may be “written” or drawn” onto a blank prior to forming. The use of laser heat with reinforcement material (metal filler) allows the formation of very specific and precise geometries thus creating a tailored increase of the strength of the blank. Put in other words, using any of these methods, the reinforcements can be tailor-made having a wide variety of shapes or designs such as e.g. circles (around areas in which a component made from such reinforced blanks may comprise holes), straight lines intersecting each other to form a grid, intermittent or broken lines and large or small figures among others. Alternatively, areas of a component made from such reinforced blanks having a complex shapes and/or having e.g. minimal radiuses such as, e.g. U-shapes may also be reinforced.

Mechanical properties of the reinforcements created depend on the geometry drawn with the reinforcement material and the laser heating process along the selected reinforcement zone.

The reinforcements (or ribs) created on the blanks later on will provide stiffness in specific areas (points or zones needing reinforcement) of a component made from such reinforced blanks. The use of any of these methods ensures that no extra weight is added with the reinforcement as material is only added in specific areas needing reinforcement. Volume and thickness of the components made from such reinforced blanks are thus optimized and the weight of the components made with such reinforced blanks is also optimized.

It has been found that these methods for creating local reinforcement lead to particularly good results in ultra-high strength steel blanks having a thickness ranging from approximately 0.7 mm to approximately 5 mm. In some examples, the ultra-high strength steel blanks may have a single thickness ranging within these values. In other examples, ultra-high strength steel blanks involving multiple thicknesses may be foreseen, e.g. tailor welded blanks and/or tailor rolled blanks and/or patchworks.

In some examples, the local reinforcement achieved on the blank may have a minimum thickness (i.e. “height”) of approximately 0.2 mm. The minimum thickness ensures the provision of increased mechanical strength in the reinforcement zone of a final component made with such reinforced blanks. In an example, the thickness of the reinforcement (i.e. the increase of the thickness with respect to that of the blank) may range from approximately 0.2 to approximately 10 mm, in particular from approximately 0.2 to approximately 6 mm, and more particularly from approximately 0.2 to approximately 2 mm.

Further in this aspect, forming is done after heating the steel blank with the locally deposited material to an austenization temperature or higher. The austenization temperature or Ac3 transformation point, referred hereinafter as “Ac3 point” depends on the material of the blank.

In some examples, the method may further comprise stamping the heated ultra-high strength steel blank with the locally deposited material.

In some examples, the method may further comprise quenching the heated steel blank with the locally deposited material. In some of these examples, quenching may be done in a portion of the stamping dies.

In other examples, the blanks may be passively hardened in ambient air from Ac3 point until a room temperature is reached.

In some examples, the reinforcement material may be supplied to the selected reinforcement zone and then laser heating is applied to melt the reinforcement material and a portion of the ultra-high strength steel blank. In others, supplying a reinforcement material to the selected reinforcement zone and applying laser heating to melt the reinforcement material and a portion of the ultra-high strength steel blank may be done substantially simultaneously.

In some examples, locally depositing a material on the reinforcement zone further comprises drawing specific geometric shapes on the first side of the ultra-high strength steel blank with the reinforcement material and the laser heating.

In some examples, the ultra-high strength steel blank may comprise a steel substrate and a metal coating layer. Examples of metal coating layers may comprise aluminum or an aluminum alloy or zinc or a zinc alloy. Examples of steel substrates or ultra-high strength steel blanks may comprise boron steel.

An example of boron steel used in the automotive is 22MnB5 steel. The composition of 22MnB5 may be summarized below in weight percentages (rest is iron (Fe) and impurities):

| C | Si | Mn | P | S |
|---|---|---|---|---|
| 0.20-0.25 | 0.15-0.35 | 1.10-1.35 | <0.025 | <0.008 |

| Cr | Ti | B | N |
|---|---|---|---|
| 0.15-0.30 | 0.02-0.05 | 0.002-0.004 | <0.009 |

Several 22MnB5 steels are commercially available having a similar chemical composition. However, the exact amount of each of the components of a 22MnB5 steel may vary slightly from one manufacturer to another. Usibor® 1500P is an example of a commercially available 22MnB5 steel manufactured by Arcelor®.

The composition of Usibor® may be summarized below in weight percentages (rest is iron (Fe) and impurities):

| C | Si | Mn | P | S | Cr | Ti | B | N |
|---|---|---|---|---|---|---|---|---|
| 0.24 | 0.27 | 1.14 | 0.015 | 0.001 | 0.17 | 0.036 | 0.003 | 0.004 |

In other examples, 22MnB5 steels may contain approximately 0.23% C, 0.22% Si, and 0.16% Cr. The material may further comprise Mn, Al, Ti, B, N, Ni in different proportions.

Various other steel compositions of UHSS may also be used in the automotive industry. Particularly, the steel compositions described in EP2735620A1 may be considered suitable. Specific reference may be had to table 1 and paragraphs 0016-0021 of EP2735620A1, and to the considerations of paragraphs 0067-0079.

In some examples, the UHSS blanks may contain approximately 0.22% C, 1.2% Si, and 2.2% Mn.

Steel of any of these compositions (both 22MnB5 steel such as e.g. Usibor® and the other compositions mentioned or referred to before) may be supplied with a coating in order to prevent corrosion and oxidation damage. This coating may be e.g. an aluminum-silicon (AlSi) coating or a coating mainly comprising zinc or a zinc alloy.

Usibor® 1500P is supplied in ferritic-perlitic phase. It is a fine grain structure distributed in a homogenous pattern. The mechanical properties are related to this structure. After heating, a hot stamping process, and subsequent quenching, a martensite microstructure is created. As a result, maximum strength and yield strength increase noticeably. Similar processes may be applicable to any other steel composition.

The amount of Si or Mn present in UHSS blanks may enable hardening the blank at a room temperature, thus avoiding a quenching process and reducing manufacturing press time. These steel compositions are also known as air-hardenable steels or self-hardening steels.

It has been found that such 22MnB5 steels may have an Ac3 point at or near 880° C. Others UHSS may have Ac3 point around 800° C. or higher.

An aspect of hot forming blanks being reinforced with any of the methods substantially as hereinbefore described is that the reinforcement material deposited on the blank will also be heated to austenization thus resulting in a reinforced component with a more homogeneous microstructure. Further the provision of a reinforcement substantially as hereinbefore described, i.e. prior to a hot forming process, avoids the formation of heat-affected zones (HAZ) and distortions that could appear in circumstances when the reinforcement material is e.g. applied on a previously formed component. Although applying reinforcement material on a previously formed component may be sufficient in circumstances. Further in the present disclosure, since the reinforcement is applied onto the blank surface before the blank is heated to austenization a dilution in the reinforcement material-blank surface interface is enhanced.

Depending on the reinforcement material and on the material of the blank, a critical cooling rate from the Ac3 point or above in order to obtain a martensitic structure may vary when using a hot forming process to form the reinforced blanks.

In some examples, supplying the reinforcement material (metal filler) may comprise supplying a metal powder in a gas powder flow. In some examples, supplying the reinforcement material may comprise supplying a solid metal provided as a metal wire. And in some examples, the reinforcement material, either in its powder or wire form, may comprise stainless steel. In some examples, the reinforcement material may be a hardenable material so as to harden after heating.

Examples of reinforcements may be selected from e.g. 316L, 410HC among others, e.g. AISI 316L, as commercially available from e.g. Hoganäs®. The reinforcement material may have the following composition in weight percentages: 0%-0.03% carbon, 2.0-3.0% of molybdenum, 10%-14% of nickel, 1.0-2.0% of manganese, 16-18% chromium, 0.0-1.0% of silicon, and the rest iron and impurities.

Alternatively 431L HC, as commercially available from e.g. Hoganäs® may be used. This material has the following composition in weight percentages: 70-80% of iron, 10-20% of chromium, 1.0-9.99% of nickel, 1-10% of silicon, 1-10% of manganese and the rest impurities.

Further examples may use 3533-10, as further commercially available from e.g. Hoganäs®. This material has the following composition in weight percentages: 2.1% carbon, 1.2% of silicon, 28% of chromium, 11.5% of nickel, 5.5% of molybdenum, 1% of manganese and the rest iron and impurities.

It may also be possible to combine these reinforcement materials. For example, a reinforcement material comprising 35% in weight of AISI 316L and 65% in weight of 431L HC exhibits good ductility and strength. Other percentages or combinations may be foreseen.

It was found that the presence of nickel in these compositions led to good corrosion resistance and promoted the austenite formation. The addition of chromium and silicon aids in corrosion resistance, and molybdenum aids in increasing the hardness. In alternative examples other stainless steels may also be used, even UHSS. In some examples, the material may incorporate any component providing different (e.g. higher) mechanical characteristics depending on circumstances.

In some examples, the reinforcement material may have a similar composition as that of the material of the blank. In these cases, the reinforcement material will have similar properties to those of the steel blanks thus resulting, i.e. once melted and formed, in a final reinforced product having a substantially homogeneous microstructure. The microstructure of a final reinforced product can also be enhanced by providing a reinforcement material able to become austenitic. In these cases, when the reinforced structural component is formed by a hot forming process, the reinforcement material can also reach austenitic phase thus enhancing the microstructure of the reinforced structural component as the reinforcement material will also be transformed into a martensite microstructure by cooling down (e.g. quenching) after the hot forming process.

In those examples in which the ultra-high strength steel blank comprises a steel substrate and a metal coating layer, the method may further comprise guiding and applying an ablating laser beam along the reinforcement zone to ablate at least a part of the coating layer of the reinforcement zone prior to locally depositing a material on the reinforcement zone.

In some of these examples, applying the ablating laser beam may be done substantially simultaneously with locally depositing a material on the reinforcement zone. The ablating laser beam may be applied at a distance between 2 mm to 50 mm upstream from the heating laser beam.

In some examples, the ultra-high strength steel blank may have a thickness in the range between 0.7 mm to 5 mm.

In some examples, the locally deposited material may have a minimum thickness of 0.2 mm, particularly 0.2 mm to 10 mm.

A further aspect provides a manufacturing system for manufacturing reinforced steel structural components. The manufacturing system comprises a reinforcement depositing system and a forming system. The reinforcement depositing system comprises a laser system having a laser beam source for generating a heating laser beam, a reinforcement material depositor; and a controller connected to the laser beam source and the reinforcement material depositor. The controller is configured to select a reinforcement zone, guide the heating laser beam along the reinforcement zone to apply laser heating and instruct the reinforcement material depositor to locally deposit a reinforcement material onto the reinforcement zone such that laser heating melts the reinforcement material and a portion of an ultra-high strength steel blank to mix the melted reinforcement material with the melted portion of the ultra-high strength steel blank. The forming system comprises a heating system arranged substantially downstream from the reinforcement depositing system, and a pair of mating dies arranged substantially downstream from the heating system. The pair of mating dies comprises one or more working surfaces that in use face the heated reinforced ultra-high strength steel blank, wherein one or more working surfaces comprises inverse geometries such as slots or other surface irregularities or recesses matching with the applied reinforcement material. The forming system is further provided with a conveyor or transferring devices for transferring the ultra-high strength steel blank from the reinforcement depositing system to the heating system and for transferring the heated reinforced ultra-high strength steel blank from the heating system to the pair of mating dies.

In some examples, the heating system may comprise a furnace or oven in which the reinforced steel blank can be heated to reach the Ac3 point or higher.

In some examples, the laser system may further comprise an ablating laser source for generating an ablating laser beam. The ablating laser source may also be connected to the controller and may be guided along the reinforcement zone to direct the ablating laser beam prior to the heating laser beam.

In some examples, guiding the heating laser beam along the reinforcement zone to apply laser heating and instructing the reinforcement material depositor to locally deposit a reinforcement material onto the reinforcement zone may be done substantially simultaneously.

In still a further aspect, the present disclosure provides a product as obtained by or obtainable by a method substantially as hereinbefore described. The resulting product may demonstrate improved characteristics as the reinforcement material and the formed product may form an homogeneous microstructure

Examples of the present disclosure may be used with blanks of different materials, and in particular different steels. Examples of the present disclosure may be used with forming systems comprising hot stamping, cold forming, roll forming, or hydroforming.

### BRIEF DESCRIPTION OF THE DRAWINGS

Non-limiting examples of the present disclosure will be described in the following with reference to the appended drawings, in which:

FIG. 1 shows an example of manufacturing a reinforced steel blank;

FIGS. 2a and 2b show other examples of manufacturing a reinforced steel blank;

FIGS. 3a-3d show examples of different specific reinforcement geometries that may be obtained by methods substantially as hereinbefore described;

FIG. 4 shows still a further example of manufacturing a reinforced steel blank;

FIGS. 5a and 5b show examples of reinforced structural components that may be made with methods substantially as hereinbefore described;

FIG. 6 shows an example of mating dies that may be used with methods substantially as hereinbefore described; and

FIG. 7 is a flow diagram of a method of manufacturing reinforced steel structural components according to an example.

### DETAILED DESCRIPTION OF EXAMPLES

In these figures the same reference signs have been used to designate matching elements.

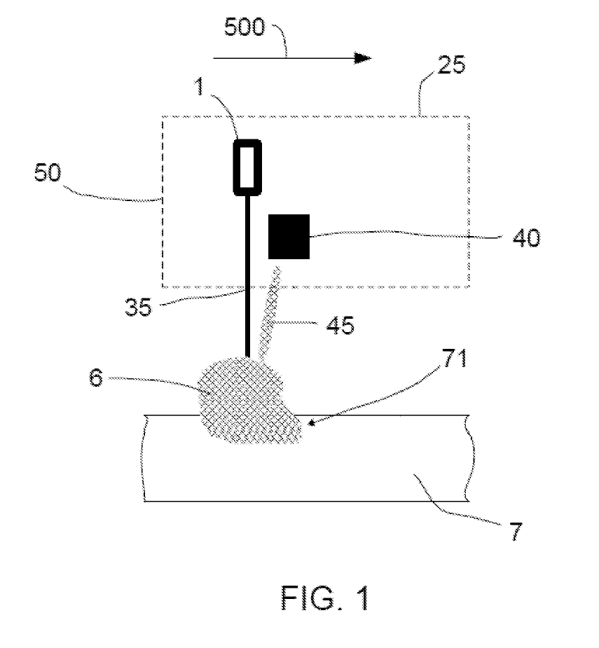

FIG. 1 shows an example of manufacturing a reinforced steel blank. A laser system 25 may comprise a laser source 1 that may generate a laser beam 35 that may be directed to a surface of the blank 7 to melt a portion 71 the blank surface. A material depositor 40 may further be provided to locally deposit a material 45 on the reinforcement zone. The laser beam 35 may heat and fuse the (reinforcement) material 45 with the portion 71 of the blank being melted by the laser beam 35.

The laser system 25 may be displaced along a first direction 500 relatively to the steel blank 7 so as to apply the laser beam 35 on the blank surface. The first direction 500 may be a direction along a path that may require reinforcement. Therefore, laser heating may take place only in a previously selected reinforcement zone of the steel blank 7 where reinforcement may be required and while substantially at the same time reinforcement material 45 from the material depositor 40 may be locally deposited. This way heat from the laser beam 35 can melt the reinforcement material 45 and a portion 71 of the steel blank so as to mix them defining the reinforcement 6. The material depositor 40 may be moveable in unison with the laser system 25.

In some examples, as shown in FIG. 1, the material depositor 40 may form part of a single reinforcement applier 50 that may include the material depositor 40 and the laser system 25. Alternatively, the material depositor may be separate from the laser system but synchronised with the laser system so as to be moveable (the laser system and the material depositor) in tandem.

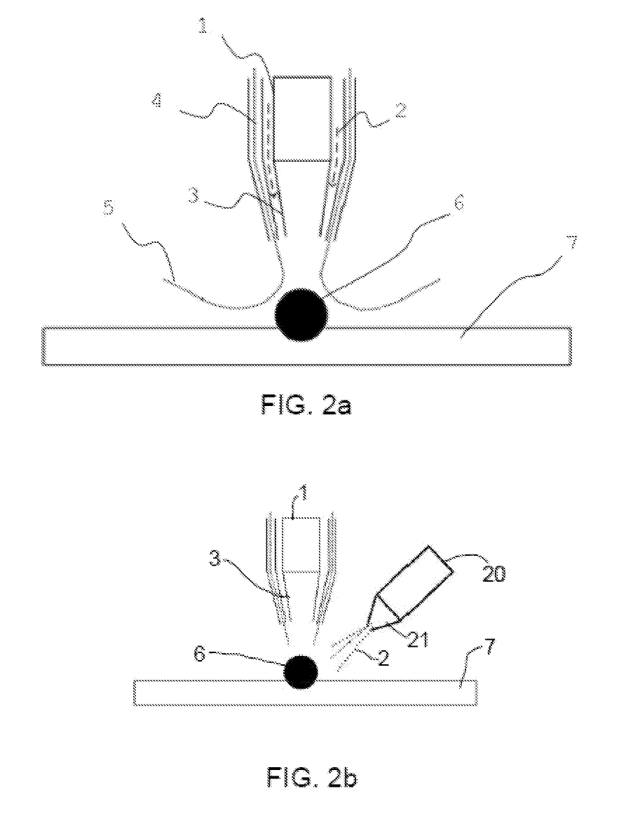

FIGS. 2a and 2b show examples of reinforcement appliers in which the material depositor may be a gas powder supply. The laser source 1 may have a laser head 3 from which the laser beam (see FIG. 1) exits.

The example of FIG. 2a shows an alternative in which the gas powder supply may be coaxially arranged with the laser head 3. In this example, the gas powder supply and the laser head may be arranged such that a gas powder flow 2, indicated with an interrupted line with arrow, and the laser beam may be substantially perpendicular to a surface of the blank 7 on which the reinforcement 6 is to be formed. Alternatively, the coaxially arranged laser head with gas powder supply may be arranged at an angle with respect to the blank. The gas powder flow 2 may be fed to the reinforcement zone while the laser beam is being applied.

The example of FIG. 2b shows another alternative in which the gas powder supply 20 with nozzle 21 may be arranged at an angle with respect to the blank 7. In this example, the gas powder supply 20 with nozzle 21 may also be arranged at an angle with respect to the laser head 3 thus the gas powder flow 2 is fed at an angle with respect to the laser beam.

In some examples, argon may be used as a transportation gas, depending on the specific implementation. Other examples of transportation gas may also be foreseen, e.g. nitrogen or helium.

The examples of FIGS. 2a and 2b further shown a shield gas channel 4 that may also be coaxially provided with respect to the laser head 3 to supply a shield gas flow 5 around the zone on which the reinforcement 6 is to be formed.

In some examples, helium or a helium based gas may be used as a shielding gas. Alternatively an argon based gas may be used. The flow rate of the shielding gas may e.g. be varied from 1 litre/min to 15 litres/min. In further examples, no shielding gas may be required.

Alternatively, a solid wire may be used to provide the reinforcement material.

The laser may have a power sufficient to melt at least an outer surface (or only an outer surface) of the component and thoroughly mix/join the powder throughout the entire zone on which the reinforcement 6 is to be formed.

In some examples, heating may comprise using a laser having a power of between 2 kW and 16 kW, optionally between 2 and 10 kW. The power of the laser should be enough to melt at least an outer surface of a blank having a typical thickness i.e. in the range of 0.7-5 mm. By increasing the power of the laser the overall velocity of the process may be increased.

Optionally, a Nd-YAG (Neodymium-doped yttrium aluminum garnet) laser may be used. These lasers are commercially available, and constitute a proven technology. This type of laser may also have sufficient power to melt an outer surface of a blank and allows varying the width of the focal point of the laser and thus of the reinforcement zone. Reducing the size of the “spot” increases the energy density, whereas increasing the size of the spot enables speeding up the heating process. The laser spot may be very effectively controlled and various types of heating are possible with this type of laser.

In alternative examples, a CO₂ laser with sufficient power or a diode laser may be used. In further examples, twin spot laser may also be used.

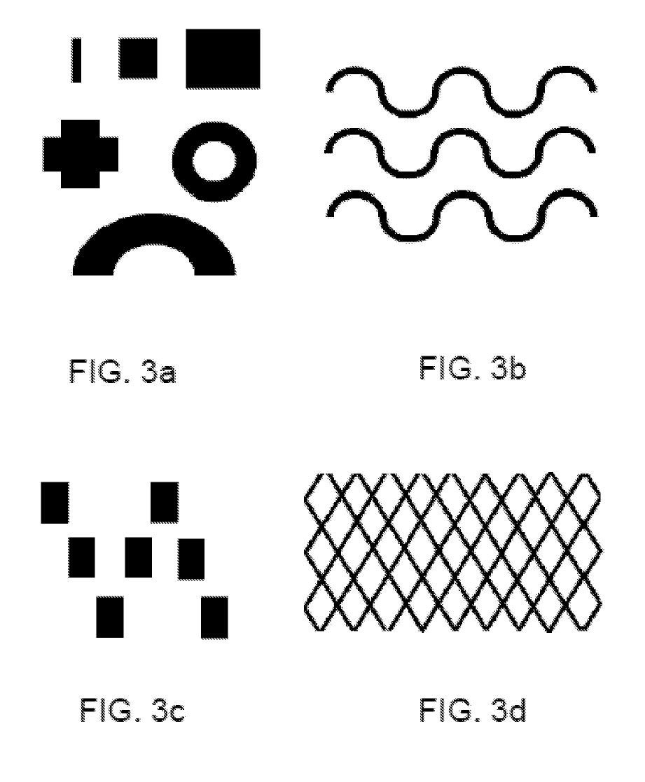

FIGS. 3a-3d show different examples of specific reinforcement geometries that may be obtained with methods substantially as hereinbefore described. As mentioned above, using a laser to melt a reinforcement material (powder or solid wire) may allow the formation of almost any desired geometry having e.g. different curvature, different size (length, width and height) or even lines crossing each other to define a grid. These methods are quite versatile. No extra material in a zone that does not need reinforcement is provided, and the final weight of a component made from blanks being reinforced substantially as hereinbefore described may thus be optimized.

For example, FIGS. 3a and 3c show different discrete known shapes such as rectangles, squares, annular rings, half a ring and a cross among other possibilities. FIG. 3b shows curved lines defining each a substantially sinusoidal form and FIG. 3d shows straight lines crossing each other to define a grid.

It has been found that local reinforcements having a minimum thickness of 0.2 mm lead to good results while optimizing the weight of a final reinforced component made from blanks being reinforced substantially as hereinbefore described. The minimum thickness may be obtained with e.g. only one material (e.g. powder or wire) deposition. Furthermore, each laser exposure and material deposition may involve a maximum thickness of approximate 1 mm. In some examples, the local reinforcement may have a thickness between approximately 0.2 mm and approximately 6 mm. This may be achieved with repetitive depositions of material or by slowing down the process. And in more examples, the local reinforcement may have a thickness between approximately 0.2 mm and approximately 2 mm. In all these examples, the width of the local reinforcement with each material deposition and laser exposure may generally be between approximately 1 mm to approximately 10 mm.

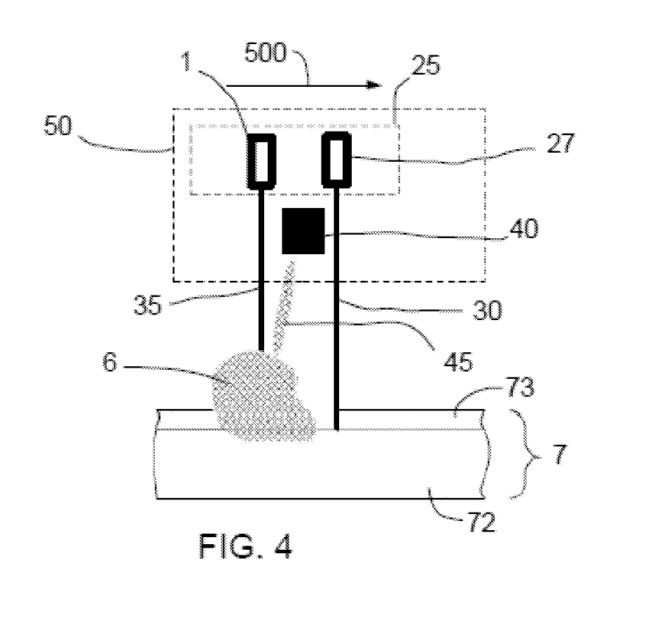

FIG. 4 shows another example of manufacturing a reinforced steel blank. The example of FIG. 4 differs from that of FIGS. 1, 2a and 2b in that the laser system 25 may further comprise an ablating laser source 27. These examples may particularly be used when reinforcing steel blanks 7 comprising a steel substrate 72 and a metal coating layer 73. As explained above, examples of metal coating layers may comprise aluminum or an aluminum alloy or zinc or a zinc alloy.

The ablating laser source 27 may generate an ablating laser beam 30. The ablating laser source 27 may be arranged such that the ablating laser beam 30 may be used to ablate a portion of the coating layer 73 prior to locally depositing the reinforcement material 45 e.g. as explained in connection with FIG. 1. The ablating laser beam 30 may be guided by the ablating laser source 27 that may be an individual laser head or may form part of a laser head or system 25 that may be shared between the ablating laser source 27 and the laser source 1. The ablating laser source 27 may be a pulsed laser, e.g. a Q-switched laser having a nominal energy of 450 W delivering a 70 nsec pulse with pulsed energy of 42 mJ.

In these examples, the laser system 25 may also be relatively displaced in a first direction 500 with respect to the steel blank 7 so as to apply the ablating laser beam 30 on the coating layer 73 of the blank prior to locally depositing the reinforcement material 45. The ablation may therefore take place only in a selected reinforcement zone of the steel blank 7 where reinforcement may be required. The reinforcement material 45 may thus be heated and melted in an ablated reinforcement zone. As used herein, term “ablation” is used to denote the at least partial elimination of a coating layer.

As the reinforcement operation progresses along the first direction the reinforcement material that has been heated and melted in the ablated reinforcement zone may begin to cool down and solidify on the ablated reinforcement zone. The solidified reinforcement material may thus cover the whole area that was ablated thus minimising corrosion zones in unprotected border areas.

The power of the ablating laser source should be enough to melt at least the coating layer of the steel blank.

The power of the ablating laser source (for example, 450 W) may thus be substantially lower than the power of the laser source (between 2 kW and 16 kW, optionally between 2 kW and 10 kW). By increasing the power of the lasers the overall velocity of the process may be increased.

Further in the examples of FIG. 4, the laser system 25 may be configured to direct a spot of the laser beam 35 at a distance (downstream) of between approximately 2 mm and approximately 50 mm from the spot of the ablating laser beam 30. In these examples, the distance between the spots of the two laser beams 30 and 35 may depend on various factors. For example, when the metal coating needs to be removed before the material deposition takes place, then the distance may be such that the deposited material may not be accidentally removed as part of the ablated material removal. In other words, any removal of coating from the ablated zone needs to be completed or take place sufficiently far away (before) deposition of reinforcement material takes place in the ablated area. One way to remove the ablated material may be with an air blowing system. However, if no further removal needs to take place (for example because the ablation process pushes the ablated coating off the reinforcement zone) then the distance between the two spots may be relatively close.

In some examples, the laser source and the ablating laser source may be comprised in a single laser system 25 or head as shown in the example of FIG. 4. This allows for the two laser beams to be precisely aligned during the entire ablation and melting process which, in turn allows for a higher speed of reinforcement.

In some examples, the laser source may be comprised in a first laser head and the ablating laser source in a second laser head. The first and second laser heads may thus be arranged to be moveable in unison. Using two laser heads allows for separate control of movement characteristics of the spots. For example, the laser head responsible for the ablation spot (or spots in case of twin-spot beam) may displace the spot in a second direction while the laser head responsible for melting the reinforcement material moves in the first direction to e.g. perform sweeping of the ablated area to remove any residues of the ablation. The second head would then only provide movement of the ablating laser beam along the first direction.

An aspect of applying the ablating laser beam prior to or substantially simultaneously with the laser beam for heating and the material deposition is that the reinforcement may be homogeneously dissolved on and adhere to the ablated area as the ablated area is already preheated from the ablating laser and the two processes (ablation and material deposition) are not separated in time and space but are performed successively before the ablated area is allowed to cool down. The reinforcement may thus adhere and dilute directly with the steel substrate in the ablating coating layer zone leaving substantially no ablated steel substrate uncovered.

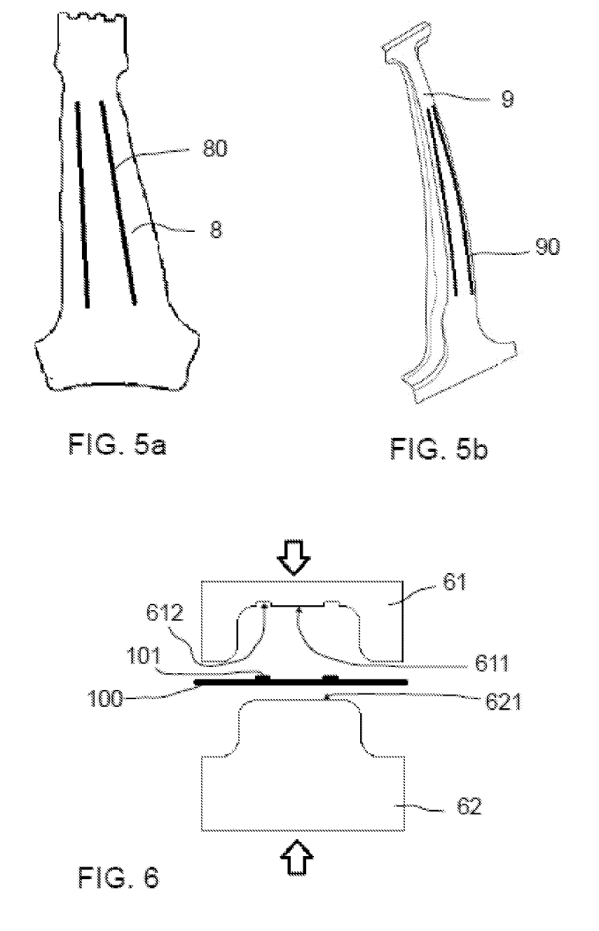

FIGS. 5a and 5b show different reinforced components obtained by any method substantially as herein described. In the example of FIG. 5a a bar 9 e.g. a cross/side member is schematically illustrated. In the example of FIG. 5b a B pillar 8 is schematically illustrated. Both components 8 and 9 may be formed e.g. by a HFDQ process of a blank reinforced by any of the methods substantially as hereinbefore described. In alternative examples, other ways of forming the component may also be foreseen such as cold forming, hydroforming or roll forming. Reinforcements 80 and 90 may be added on the blank prior to forming, either with a prior ablating step as explained in connection with FIG. 4, i.e. by ablating the coating layer and depositing a reinforcement material while applying the laser beam to melt the reinforcement material or as explained in connection with FIGS. 1-2b, i.e. by applying the laser beam substantially simultaneously with the reinforcement material on a blank surface.

The reinforcements 80 and 90 are designed e.g. to direct tensions and increase stiffness (rigidity) of the final component that will be made with such a reinforced blank. The reinforcements may be applied e.g. in order to improve strength in case of an impact in areas such as corners, end portions and e.g. in order to add strength to the component due to e.g. a hole made during manufacture so that the whole strength of the final component that is made with such a reinforced blank is not affected by the presence of the hole. In general in a component, reinforcements may be required in those areas that need to withstand most loads, e.g. in a B pillar these areas are the corners.

FIG. 6 shows a press tool configured to form a reinforced blank by any of the methods substantially as hereinbefore described, e.g. by a HFDQ process or a cold forming process.

The press tool may comprise upper 61 and lower 62 mating dies and a mechanism (not shown) configured to provide upwards and downwards press progression (see arrows) of the upper die 61 with respect to the lower die 62. A press progression mechanism may be driven mechanically, hydraulically of servo-mechanically. The upper die 61 and the lower die 62 may respectively comprise an upper working surface 611 and a lower working surface 621 that in use face the reinforced blank 100 to be formed or hot formed.

In the example of FIG. 6, the upper working surface 611 may comprise a pair of slots or recesses 612 defining an inverse geometry of a reinforcement 101 of a blank reinforced by any of the methods substantially as hereinbefore described. In further examples, other number of slots or recesses may be provided depending on the reinforcements applied to the reinforced blanks.

Alternatively, both working surfaces (upper and lower) may comprise slots or recesses matching a reinforced material that may be applied at both sides of a blank by any of the methods substantially as hereinbefore described.

Depending if a cold forming or a hot forming process is to be performed by the press tool, the upper and lower mating dies may comprise e.g. channels with cold fluid e.g. water and/or cold air passing through the channels provided in the dies. In the water channels, the speed of circulation of the water at the channels may be high, thus the water evaporation may be avoided. The channels with cold fluid allow cooling down of the reinforced blank being formed at a rate such that a final reinforced formed component results in a martensite microstructure.

A control system may further be provided, thus the temperature of the dies may be controlled. In further examples, other ways of adapting the dies to operate at lower or higher temperatures may also be foreseen, e.g. in circumstances, heating systems may be provided to control the cooling rate and/or to create areas having a ferrite-pearlite microstructure, i.e. soft zones which are zones in the component having reduced mechanical strength as compared to other parts of the component. Temperature sensors and control systems may also be provided to control the temperature of the dies and/or in transferring systems that may be used for conveying the blanks from e.g. the oven to the press tool.

Automatic transfer devices, e.g. a plurality of industrial robots, or a conveyor may also be provided to transfer of blanks e.g. from the oven to the press tool. In more examples, one or more centering elements, e.g. pins and/or guiding devices, may also be provided to aid centering the reinforced blanks in the dies working surfaces.

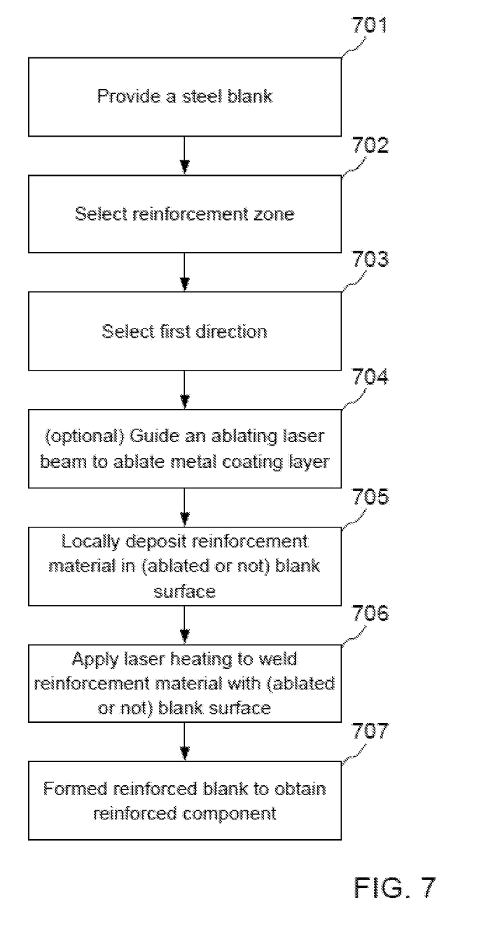

FIG. 7 is a flow diagram of a method of manufacturing reinforced steel blank according to an example. At a first block 701, a steel blank is provided. In some examples, the steel blank may have a coating layer of aluminum or of an aluminum alloy. Alternatively other metal coating layers may be foreseen e.g. including a zinc or zinc alloy coating layer. In more alternatives, no metal coating layer may be present in the steel blank.

In all cases, at block 702, a reinforcement zone of the steel blank may be selected. At block 703, a first direction in the reinforcement zone may be selected. Then, when blanks comprising a metal coating layer are being used, at block 704, an ablating laser beam may be guided along the first direction to ablate at least a part of the metal coating layer of the reinforcement zone.

In all cases, at block 705, a material may be locally deposited on the reinforcement zone (which may be or have been ablated or not) to create a local reinforcement on a first side of the blank. At block 706, laser heating may be substantially simultaneously applied with the material deposition, along the first direction to melt the reinforcement material (metal filler) and create the reinforcement. At block 707, the reinforced blank may be formed to obtain the reinforced structural component. In circumstances a further intermediate step may include actively cooling or allowing to cool in ambient air the reinforced blank prior to the forming process to let the reinforcement material adhere to the (ablated or not) steel surface of the blank.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A method for manufacturing reinforced steel structural components, the method comprising
providing an ultra-high strength steel blank,
selecting one or more reinforcement zones of the steel blank,
locally depositing a material on the reinforcement zone to create a local reinforcement on a first side of the steel blank, wherein locally depositing a material on the reinforcement zone comprises
supplying a reinforcement material to the selected reinforcement zone, and
applying laser heating to melt the reinforcement material and a portion of the steel blank to mix the melted reinforcement material with the melted portion of the steel blank, and
the method further comprising
forming the steel blank with the locally deposited material to shape the reinforced steel structural component, wherein forming is done after heating the steel blank with the locally deposited material to an austenization temperature.

2. The method of claim 1, further comprising stamping the heated steel blank with the locally deposited material.

3. The method of claim 2, wherein the method further comprises quenching the heated steel blank with the locally deposited material.

4. The method of claim 1, wherein supplying a reinforcement material to the selected reinforcement zone and applying laser heating to melt the reinforcement material and a portion of the steel blank is done simultaneously.

5. The method of claim 1, wherein locally depositing a material on the reinforcement zone further comprises drawing specific geometric shapes on the first side of the steel blank with the reinforcement material and the laser heating.

6. The method of claim 1, wherein supplying the reinforcement material comprises supplying a metal powder in a gas powder flow.

7. The method of claim 1, wherein supplying the reinforcement material comprises supplying a metal wire.

8. The method of claim 1, wherein the reinforcement material comprises stainless steel.

9. The method of claim 1, wherein the ultra-high strength steel blank is made from boron steel.

10. The method of claim 1, wherein the ultra-high strength steel blank comprises a steel substrate and a metal coating layer and the method further comprises guiding and applying an ablating laser beam along the reinforcement zone to ablate a at least a part of the coating layer of the reinforcement zone prior to locally depositing a material on the reinforcement zone.

11. The method of claim 10, wherein applying the ablating laser beam is done simultaneously with locally depositing a material on the reinforcement zone, the ablating laser beam being applied at a distance between 2 mm to 50 mm upstream from the heating laser beam.

12. The method of claim 1, wherein the ultra-high strength steel blank has a thickness in the range between 0.7 mm to 5 mm.

13. The method of claim 1, wherein the locally deposited material has a thickness from 0.2 mm to 10 mm.

14. A manufacturing system for manufacturing reinforced steel structural components, the manufacturing system comprising a reinforcement depositing system and a forming system, wherein the reinforcement depositing system comprises
a laser system having
a laser beam source for generating a heating laser beam,
a reinforcement material depositor; and
a controller connected to the laser beam source and the reinforcement material depositor, wherein the controller is configured to select a reinforcement zone, guide the heating laser beam along the reinforcement zone to apply laser heating and instruct the reinforcement material depositor to locally deposit a reinforcement material onto the reinforcement zone such that laser heating melts the reinforcement material and a portion of an ultra-high strength steel blank to mix the melted reinforcement material with the melted portion of the ultra-high strength steel blank, and the forming system comprises
a heating system arranged downstream from the reinforcement depositing system, the heating system being configured to heat the blank with the reinforcement material to an austenization temperature, and
a pair of mating dies arranged downstream from the heating system, the pair of mating dies comprising one or more working surfaces that in use face the heated reinforced ultra-high strength steel blank, wherein one or more working surfaces comprises inverse geometries corresponding to the applied reinforcement material, wherein the forming system is further provided with a conveyor or transferring devices for transferring the ultra-high strength steel blank from the reinforcement depositing system to the heating system and for transferring the heated reinforced ultra-high strength steel blank from the heating system to the pair of mating dies.

15. The manufacturing system of claim 14, wherein the laser system further comprises an ablating laser source for generating an ablating laser beam, wherein the ablating laser source is also connected to the controller and is guided along the reinforcement zone to direct the ablating laser beam prior to the heating laser beam.

16. A product as obtainable by a method according to claim 1.
